(19) United States
(12) Patent Application Publication
(10) Pub. No.: US 2016/0016814 A1
(43) Pub. Date: Jan. 21, 2016

(54) PREPARATION OF CHROMIUM(IV) OXIDE MATERIALS

(71) Applicant: Michael Pesek Marshak, Cambridge, MA (US)

(72) Inventor: Michael Pesek Marshak, Cambridge, MA (US)

(21) Appl. No.: 14/800,692

(22) Filed: Jul. 15, 2015

Related U.S. Application Data
(60) Provisional application No. 62/025,081, filed on Jul. 16, 2014.

(51) Int. Cl. C01G 45/02; C01G 37/14; C01G 37/027

(52) U.S. Cl. CPC C01G 45/02; C01G 37/027; C01G 37/14

(57) ABSTRACT

A novel process for the manufacture of materials containing chromium(IV) oxide from precursor molecules that contain chromium in the formal oxidation state of +4 is described.

### CROSS REFERENCE TO RELATED APPLICATIONS

This application claims priority to U.S. Provisional Application No. 62/025,081, which was filed on Jul. 16, 2014.

### TECHNICAL FIELD

This disclosure relates to chromium compositions such as chromium (IV) oxides and Cr(IV) precursor compositions used for making the same, which can be used to make chromium materials including particles, particle solutions, films, alloys, and related materials.

### BACKGROUND

Chromium(IV) oxide is the only binary metal oxide known to be both ferromagnetic and conductive, and it has been investigated as a material for catalysis, magnetic audio tape, photovoltaics, superconductors, spintronics, fuel cells, and lithium battery anodes.

Chromium(IV) oxide is typically synthesized under high oxygen pressures from chromium trioxide (CrO₃) and/or chromyl chloride (CrO₂Cl₂) precursors, and is unstable above 300° C. where it is thermally reduced to form chromium(III) oxide (Cr₂O₃) and oxygen O₂. In addition to the synthetic challenges surrounding chromium(IV) oxide, the toxicity of chromium(VI) precursors (CrO₃) has limited the development of chromium(IV) oxide particles and films.

Molecular chromium compounds that contain chromium in the +4 oxidation state and between one to six organic ligands have been known since at least 1959, but their use as precursors for chromium-containing materials such as chromium(IV) oxide has not been described.

Some varieties of CrO₂ particles and films have been reported and used in a variety of applications. See Hwang, H. Y. & Cheong, S.-W. Enhanced Intergrain Tunneling Magnetoresistance in Half-Metallic CrO₂ Films. Science 278, 1607-1609 (1997); Soulen, R. J. et al. Measuring the Spin Polarization of a Metal with a Superconducting Point Contact. Science 282, 85-88 (1998); Park, J.-H. et al. Direct evidence for a half-metallic ferromagnet. Nature 392, 794-796 (1998); Prinz, G. A. Magnetoelectronics. Science 282, 1660-1663 (1998); Ohno, H. Making Nonmagnetic Semiconductors Ferromagnetic. Science 281, 951-956 (1998); Monsma, D. J., Vlutters, R. & Lodder, J. C. Room Temperature-Operating Spin-Valve Transistors Formed by Vacuum Bonding. Science 281, 407-409 (1998); Wolf, S. A. et al. Spintronics: A Spin-Based Electronics Vision for the Future. Science 294, 1488-1495 (2001); Åkerman, J. Toward a Universal Memory. Science 308, 508-510 (2005); Keizer, R. S. et al. A spin triplet supercurrent through the half-metallic ferromagnet CrO₂. Nature 439, 825-827 (2006); Eschrig, M. & Löfwander, T. Triplet supercurrents in clean and disordered half-metallic ferromagnets. Nature Phys. 4, 138-143 (2008). But in all of these cases, impurities limited the extent to which the desired magnetic and magnetoresistive properties could be observed.

CrO₂ compositions, such as particles and films, have been made with methods using chromium precursors having chromium in oxidation states other the 4+. See, e.g., Paul, A. J. Ferromagnetic chromium oxide and method of making; U.S. Pat. No. 2,956,955 A, Oct. 18, 1960; L, C. N. Process for producing ferromagnetic chromium oxide. U.S. Pat. No. 3,074,778 A, Jan. 22, 1963; Paul, A. J.; N, I. J. Process for the preparation of ferromagnetic chromium dioxide. U.S. Pat. No. 3,117,093 A, Jan. 7, 1964; Buichi, K.; Hiroyuki, C.; Minorn, S.; Tomozo, N. Method for preparing CrO₂ of rutile type crystalline structure. U.S. Pat. No. 3,243,260 A, Mar. 29, 1966; Cox, N. L. Ferromagnetic chromium dioxide and preparation thereof. U.S. Pat. No. 3,278,263 A, Oct. 11, 1966; Cox, N. L.; Hicks, W. T. Preparation of ferromagnetic CrO₂ by heating CrO₃ in the presence of O₂ and Cr₂O₃. U.S. Pat. No. 3,451,771 A, Jun. 24, 1969; Hicks, W. T. Formation of ferromagnetic CrO₂ by decomposition of higher valent chromium oxides. U.S. Pat. No. 3,486,851 A, Dec. 30, 1969; Jr, B. J. H. Process for preparing chromium dioxide and product thereof. U.S. Pat. No. 3,449,073 A, Jun. 10, 1969; Jr, J. H. B. Preparation of ferromagnetic chromium dioxide. U.S. Pat. No. 3,423,320 A, Jan. 21, 1969; Hicks, W. T.; Jacobson, H. W. Process for preparing ferromagnetic materials. U.S. Pat. No. 3,493,338 A, Feb. 3, 1970; Mehra, V.; Jr, W. R. W. Process of producing electric current in fuel cell using chromium dioxide catalyst. U.S. Pat. No. 3,499,798 A, Mar. 10, 1970; Hirota, E.; Mihara, T.; Terada, Y. Method for making ferromagnetic chromium dioxide. U.S. Pat. No. 3,575,689 A, Apr. 20, 1971; Hund, F. Chromium-dioxide-catalyst. U.S. Pat. No. 3,667,913 A, Jun. 6, 1972; Jr, J. H. B.; Gilbert, W. W. Process for the preparation of ferromagnetic chromium oxide by removing water before cooling synthesis mixture. U.S. Pat. No. 3,634,030 A, Jan. 11, 1972; Rodi, F. Process for the production of ferromagnetic chromium dioxide. U.S. Pat. No. 3,696,039 A, Oct. 3, 1972; F, H.; F, R. Ferromagnetic chromium dioxide. U.S. Pat. No. 3,725,281 A, Apr. 3, 1973; Y, F.; I, O. Process for preparing ferromagnetic chromium dioxide. U.S. Pat. No. 3,842,011 A, Oct. 15, 1974; Aspes, P.; Basile, G.; Foco, L.; Montiglio, U. Preparation of ferromagnetic chromium dioxide having granulometric and magnetic characteristics varying within wide limits as well as a new chromium dioxide of particular granulometric characteristics. U.S. Pat. No. 3,911,095 A, Oct. 7, 1975; Aspes, P.; Basile, G.; Montiglio, U.; Morero, D. Process for preparing ferromagnetic chromium dioxide. U.S. Pat. No. 3,929,978 A, Dec. 30, 1975; Robbins, H. Method for making ferromagnetic chromium dioxide. U.S. Pat. No. 3,875,297 A, Apr. 1, 1975; Williston, D. W.; Bancroft, L. C.; Hiller, D. M. Process for the preparation of ferromagnetic chromium dioxide. U.S. Pat. No. 4,045,544 A, Aug. 30, 1977; Montiglio, U.; Gallinotti, E.; Aspes, P.; Basile, G. Process for preparing ferromagnetic chromium dioxide. CA1049250 A1, Feb. 27, 1979; Terada, Y.; Kawamata, T.; Hirota, E. Method for producing a ferromagnetic chromium oxide. CA 1046239 A1, Jan. 16, 1979; Basile, G.; Mazza, A. Process for preparing ferromagnetic chromium dioxide. CA1090555 A1, Dec. 2, 1980; Williston, D. W.; Bancroft, L. C.; Hiller, D. M. Process for the preparation of ferromagnetic chromium dioxide. CA1091919 A1, Dec. 23, 1980; Ohlinger, M.; Vaeth, G.; Mueller, N.; Wettstein, E. Process for the manufacture of ferromagnetic chromium dioxide. U.S. Pat. No. 4,340,494 A, Jul. 20, 1982; Dombrowski, H. S. Surface modified ferromagnetic chromium dioxide. EP0078042 A1, May 4, 1983; Chen, H.-Y.; Crandall, T. G.; Bertoncino, J. W. Process for synthesis of ferromagnetic chromium dioxide. U.S. Pat. No. 4,769,165 A, Sep. 6, 1988; Steck, W.; Haberkorn, H.; Marosi, L.; Huebner, W.; Jakusch, H. Preparation of ferromagnetic chromium dioxide. U.S. Pat. No. 4,781,851 A, Nov. 1, 1988; Chen, H.-Y. Controlled initiation chromium dioxide synthesis. EP0146127 B1, Dec. 13, 1989; Lau, H.-P. P.; Yang, E. K.; Jacobson, H. W. Coated chromium dioxide particles. CA1289873 C, Oct. 1, 1991; Mueller, M. W.; Schwab, E.; Auweter, H.; Feser, R.; Huebner, W.; Mueller, N.; Ohlinger, M.; Dikow, H. Chromium dioxide material, its preparation and magnetic recording media containing this chromium dioxide material. U.S. Pat. No. 5,096,779 A, Mar. 17, 1992; Bajpai, A.; Nigam, A. K. Chromium dioxide (CrO₂) and composites of chromium dioxide and other oxides of chromium such as CrO₂/Cr₂O₃ and CrO₂/Cr₂O₅) and process for manufacturing the same. U.S. Pat. No. 7,276,226 B2, Oct. 2, 2007. Nevertheless, despite this work with various chromium precursors, the state of the art does not include methods of making CrO₂ materials by using Cr(IV) compounds as precursors.

There exists an ongoing need for methods of using Cr(IV) precursor materials to make a pure CrO₂ film because such methods would enable nanometer-scale magnetoresistive random access memory (MRAM), which would enable inexpensive Giga and Terabyte-scale data storage that would use a fraction of the energy of conventional and solid state hard drives and RAM. MRAM devices currently need to be very large to see an effect, limiting their date storage density and usefulness.

### DETAILED DESCRIPTION

Disclosed herein are compounds and compositions (e.g., particles, particle solutions, layered particles, alloys, layers, etc.) having chromium oxide in the +4 oxidation state and methods for making chromium(IV) oxide (aka Cr(IV)O₂ or CrO₂) materials from precursor materials comprising chromium in the formal oxidation state of +4. These new materials provide a variety of advantages beyond the state of the art. Throughout this disclosure, the oxidation state of a metal may be determined by commonly accepted electron counting formalisms and designated as either a roman numeral, such as “Cr(IV)O₂,” as an arabic numeral, such as “oxidation state of +4,” or other means of referring to the formal oxidation state on a particular metal. See Tarr, Donald A and Miessler, Gary L Inorganic Chemistry, 4th Ed. Upper Saddle River:Prentice Hall, 2011.

One use for the disclosed CrO₂ thin films is in the field of spintronics, which describes the use of electron spin in electronic devices in addition to electric charge. In magnetic materials, the valence and conduction bands have different energies for electrons that are spin-up and spin-down. In most cases this results in only modest differences in resistance, but in the case of CrO₂ the band structure for the spin-up electrons is conducting, while it is insulating for the spin-down electrons. Thus CrO₂ can been described as a half-metal, because conductivity is observed only for electrons of one particular spin.

Ferromagnetic CrO₂ has also displayed superconducting characteristics, which contradicts the conventional theory that electrons are conducted as singlet pairs. Although spin in superconducting materials is still controversial, the ability to control the conductivity of electrons by their spin enable elucidation of new physical phenomena. Cr(IV)-based perovskite materials such as BaCrO₃ provide half-metallic compounds, which are in integral piece in forming a new class of high-temperature superconductors.

Also disclosed herein are methods of making chromium(IV) oxide materials comprising depositing chromium(IV) oxide precursor materials in a volatile phase (e.g., the gas or vapor phase). In one embodiment, chromium (IV) oxide materials are provided at temperatures below about 300° C. by depositing volatile chromium(IV) oxide precursor materials at temperatures below about 300° C., such as between about 150 to 290° C., for example about 250° C.

Also disclosed herein are alloys of chromium(IV) oxide with other metal-containing materials.

Also disclosed herein are methods of making chromium compositions that are substantially free from chromium precursors in the formal oxidation state of +6, aka “Chromium (VI) compounds.”

Disclosed herein are chromium(IV) oxide materials, which are suitable for use in solution based hydrolysis (sol-gel) reactions. In one embodiment the disclosed chromium(IV) oxide materials are suitable for use in chemical vapor deposition. In one embodiment the disclosed chromium(IV) oxide materials are suitable for use in atomic layer deposition.

The disclosed chromium(IV) oxide precursor compounds (e.g., Cr(IV)R₄) may be reacted with an oxygen atom source such as oxygen gas, ozone, water, hydrogen peroxide, silanol, or aryl hydrate. Other oxygen sources are also contemplated for use within the context of this disclosure, so long as the oxygen source is capable to transferring one or more oxygen atoms to another compound.

In one or more embodiments, the chromium(IV) oxide precursor material (used to make Cr(IV)O₂) has the following structural formula:

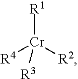

wherein each of R¹, R², R³, and R⁴ is independently selected from substituted or unsubstituted alkyl, aryl, alkoxide, siloxide, amide, imide, amidine, and other monoanionic groups comprising non-metallic atoms.

Disclosed herein is a method of making a chromium composition (e.g., Cr(IV)O₂) comprising reacting a chromium compound having chromium in the formal oxidation state of +4 with an oxygen atom source.

As used herein the term “chromium composition” refers to a chemical composition that includes the element chromium (“Cr”), including pure chromium compounds and mixtures thereof in any proportions. One example of a “chromium composition” within the context of this disclosure is a chromium compound having the following structural formula:

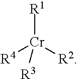

The Cr(IV)O₂ compositions provided in this disclosure may made into a variety of forms, such as particles, particle solutions, coated particle solutions, layered particles, alloys, layers, etc.

Within the context of this disclosure the term “particle solution” means a colloidal suspension of particles ranging from 1 nm to 100 micrometers.

As used herein, the term “coated particle solution,” means a particle that has one material at its core, and another on the surface. Within the context of this disclosure one example of a “coated particle solution” would include 10 nm CrO₂ nanoparticles, coated with 2 nm of SiO₂. The resulting composition provides the benefit of behaving like a magnetic silica gel.

As used herein the term “formal oxidation state” refers to the numerical “oxidation state” or “oxidation number” value determined by following a systematic scheme well recognized in the art and described in general chemistry textbooks. One example of a chromium composition having a formal oxidation state of +4 includes CrO₂, where the formal oxidation state of Cr is assigned +4. Some examples of chromium compounds having a formal oxidation state of +4, which could be used to make CrO₂, where the formal oxidation state of Cr is assigned +4 include the following: Cr(CH₂Si(Me)₃)₄; Cr(CH₂^{t}Bu)₄; Cr(CH₂CPhMe₂)₄; Cr(NEt₂)₄; Cr(NMeⁿBu)₄, Cr(NⁿPr₂); Cr(NC₅H₁₀)₄; Cr(O^{t}Bu)₄; Cr(OCMe₂Et)₄: Cr(OCMeEt₂)₄: Cr(OCH^{t}Bu₂)₄; Cr(1-adamantoxide).

As used herein, the term “oxygen source” means a source of at least one oxygen atom, designated with the symbol “O” on the periodic table of the elements. In one embodiment the “oxygen source” comprises one or more molecules including at least one oxygen atom, which can transfer that oxygen atom to another molecule, thereby serving as a “source” of oxygen.

Disclosed herein is a method of making a chromium composition, comprising reacting a chromium compound having chromium in the formal oxidation state of +4 with an oxygen atom source that is chosen from water, oxygen, ozone, hydrogen peroxide, silanol, or aryl hydrate.

Disclosed herein is a method of making a thin film composition comprising:

treating a heated substrate with (A) one or more volatile chromium compounds in the formal oxidation state of +4 and (B) a gas or vapor chosen from water, oxygen, ozone, hydrogen peroxide, silanol, or aryl hydrate.

As used herein, the term “thin film” means a layer of material than is substantially more expansive in width and length (often referred to as the x- and y-coordinates) than it is in height (often referred to as the z-coordinate).

Vapor deposition is one method for making thin films. Vapor deposition is a generic term that comprises chemical vapor deposition (CVD) and atomic layer deposition (ALD).

In a CVD process, one or more vapors are delivered to a surface on which solid material is deposited; the chemical reactions that convert the vapor to a solid are initiated by means such as heat, light or electrical excitation (e.g., plasma activation).

In an ALD process, two or more vapors are delivered alternately to the surface on which reactions take place to deposit a solid product. ALD is capable of depositing these materials inside the very narrow structures in modern DRAMs. CVD generally provides higher deposition rates than ALD, but with less uniform deposition inside very narrow holes.

Within the context of this disclosure, ALD should be understood to include depositing materials on any surface suitable for atomic layer deposition. Within the context of the disclosure, suitable surfaces include Si, SiO₂, TiO₂, and Al₂O₃.

Within the context of this invention, compounds used for vapor deposition should be volatile, thermally stable, and reactive.

As used herein the term “heated substrate” means a solid material, suitable for deposition of a volatile chemical, which as been supplied with sufficient heat energy to elevate the temperature above the ambient temperature. In one embodiment, the “heated substrate” is between 100° C. to 500° C. when treated with one or more volatile chromium compounds. In one embodiment, the “heated substrate” is between 150° C. to 450° C. when treated with one or more volatile chromium compounds. In one embodiment, the “heated substrate” is between 200° C. to 400° C. (e.g., about 250° C.) when treated with one or more volatile chromium compounds. In one embodiment, the “heated substrate” is between 250° C. to 350° C. when treated with one or more volatile chromium compounds. In one embodiment, the “heated substrate” is between 150° C. to 290° C., such as between 200-240° C., when treated with one or more volatile chromium compounds. In one embodiment, the “heated substrate” is maintained at temperatures and conditions sufficient to minimize the thermal degradation of Cr(IV)O₂.

Disclosed herein is a method of making a composition having the chemical formula MCrO₃, comprising: reacting a chromium composition with an oxygen atom source and a salt of a divalent metal; wherein M is a divalent metal cation.

As used herein the term “divalent metal” means a metal atom (“M”) having two coordinated sites as illustrated by the following generic formula for a “divalent metal salt”: MX₂.

Disclosed herein is a method of making a composition having the chemical formula MCrO₃, comprising: reacting a chromium composition with an oxygen atom source and a salt of a divalent metal, wherein the divalent metal (within the divalent metal salt) is chosen from Be, Mg, Ca, Sr, Ba, Mn, Fe, Co, Ni, Cu, Zn Cd, Hg, Sn, or Pb.

Disclosed herein is a method of making a composition having the chemical formula MCrO₃, comprising: reacting a chromium composition with an oxygen atom source and a salt of a divalent metal, wherein the Cr atom in the composition having the chemical formula MCrO₃ is in the +4 oxidation state.

Disclosed herein is a method of making a composition having the chemical formula MCrO₃, comprising: reacting a chromium composition with an oxygen atom source and a salt of a divalent metal; wherein the oxygen atom source is chosen from water, oxygen, ozone, hydrogen peroxide, silanol, or aryl hydrate.

Disclosed herein is a method of making a composition having the chemical formula MCrO₃, comprising: reacting a chromium composition with an oxygen atom source and a salt of a divalent metal; wherein the salt of a divalent metal is chosen from MgCl₂, CaO, or BaCO₃.

In some embodiments of the above-described methods, the chromium composition reacted with an oxygen atom source has following structural formula:

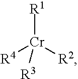

wherein each of R¹, R², R³, and R⁴ is independently chosen from a monoanionic ligand.

As used herein, the term “monoanionic ligand” means a ligand having a formal charge of −1, as assigned by the standard electronic and charge assignment formalisms accepted in the chemical community and described in general chemistry textbooks. Non-limiting examples of mono anionic ligands include the following: alkyl, aryl, alkoxide, siloxide, amide, ether, imide, and amidine, such as O^{t}Bu, OCMe₂Et, OCMeEt₂, OCH^{t}PBu₂, 1-adamantoxide, NEt₂, NMeⁿBu, NⁿPr₂, NC₅H₁₀, NC₄H₄ (pyrolyl), CH₂SiMe₃, CH₂^{t}Bu, CH₂CPhMe₂, 1-norbomyl, cyclopentadienyl, or OSi^{t}Bu₂Me.

In one embodiment, each of R¹, R², R³, and R⁴ is independently chosen from an alkyl, aryl, alkoxide, siloxide, amide, ether, imide, and amidine, wherein each mono anionic ligand may be substituted or unsubstituted; and wherein each alkyl may be saturated or unsaturated.

In one embodiment, each of R¹, R², R³, and R⁴ is independently chosen from O^{t}Bu, OCMe₂Et, OCMeEt₂, OCH^{t}Bu₂, 1-adamantoxide, NEt₂, NMeⁿBu, NⁿPr₂, NC₅H₁₀, NC₄H₄ (pyrolyl), CH₂SiMe₃, CH₂^{t}Bu, CH₂CPhMe₂, 1-norbornyl, cyclopentadienyl, or OSi^{t}Bu₂Me.

Also disclosed herein is a method of making a composition comprising: reacting a compound having manganese in the formal oxidation state of +4 with water, oxygen, ozone, hydrogen peroxide, or aryl hydrate.

### EXAMPLES

Below are provided several examples intended to illustrated specific embodiments of this disclosure. These examples are illustrative and not intended to be limiting of the broader scope of the disclosure. General considerations for the new methods illustrated below can be found, for example, in U.S. Pat. No. 7,638,645 which is hereby incorporated by reference in its entirety.

### Example 1

### Synthesis of Chromium(IV) Oxide Particle Solution from Tetrakis(Tertbutoxy)Chromium(IV) and Water

A 20 mL solution of 5 mol % water in tetrahydrofuran (THF) was added dropwise to a stirred solution of Cr(O^{t}Bu). (1 g) in 200 mL THF. The solution was heated to 60° C. for two hours and then cooled to 25° C.

### Example 2

### Synthesis of Titanium(IV)-Chromium(IV) Oxide Particle Solution from Tetrakis(Tertbutoxy)Chromium(IV), Tetrakis(Tertbutoxy)Titanium(IV), and Water

The procedure is identical to example 1 except that a 200 mL THF solution of tetrakis(tertbutoxy)chromium(IV) (0.5 g) and tetrakis(tertbutoxy)titanium(IV) (0.5 g) was used.

### Example 3

### Synthesis of Silicon(IV)-Chromium(IV) Oxide Particle Solution from Tetrakis(Tertbutoxy)Chromium(IV), Silicon Tetrachloride, and Water

The procedure is identical to example 1 except that a 200 mL THF solution of tetrakis(tertbutoxy)chromium(IV) (0.5 g) and silicon tetrachloride (0.5 g) was used.

### Example 4

### Synthesis of Titanium(IV) Oxide Coated Chromium(IV) Oxide Particle Solution from Tetrakis(Tertbutoxy)Chromium(IV), Tetrakis(Tertbutoxy)Titanium(IV), and Water

To the solution obtained in example 1 was added a 100 mL THF solution of tetrakis(tertbutoxy)titanium(IV) (0.5 g).

### Example 5

### Synthesis of Silicon(IV) Oxide Coated Chromium(IV) Oxide Particle Solution from Tetrakis(Tertbutoxy)Chromium(IV), Silicon Tetrachloride, and Water

To the solution obtained in example 1 was added a 100 mL benzene solution of silicon tetrachloride (0.5 g).

### Example 6

### Atomic Layer Deposition of Chromium(IV) Oxide from Tetrakis(Tertbutoxy)Chromium(IV) and Water

10 nmol cm⁻² doses of the vapor of tetrakis(tertbutoxy)chromium(IV) from a direct liquid injection system at 200° C. are introduced with an exposure of 10 Torr-sec into an ALD reactor at 250° C., alternately with 20 nmol cm⁻² doses of water vapor at an exposure of 10 Torr-sec. A film of chromium(IV) oxide is deposited.

### Example 7

### Atomic Layer Deposition of Chromium(IV) Oxide from Tetrakis(Neopentyl)Chromium(IV) and Water

10 nmol cm⁻² doses of the vapor of tetrakis(neopentyl)chromium(IV) from a direct liquid injection system at 200° C. are introduced with an exposure of 10 Torr-sec into an ALD reactor at 250° C., alternately with 20 nmol cm⁻² doses of water vapor at an exposure of 10 Torr-sec. A film of chromium(IV) oxide is deposited.

### Example 8

### Atomic Layer Deposition of Chromium(IV) Oxide from Tetrakis(Diethylamide)Chromium(IV) and Water

10 nmol cm⁻² doses of the vapor of tetrakis(diethylamide)chromium(IV) from a direct liquid injection system at 200° C. are introduced with an exposure of 10 Torr-sec into an ALD reactor at 250° C., alternately with 20 nmol cm⁻² doses of water vapor at an exposure of 10 Torr-sec. A film of chromium(IV) oxide is deposited.

### Example 9

### Atomic Layer Deposition of CrxTi(1-x)O2 from Tetrakis(Tertbutoxy)Chromium(IV) and Tetrakis(Tertbutoxy)Titanium(IV) and Water

10 nmol cm⁻² doses of the vapor of tetrakis(tertbutoxy)chromium(IV) and tetrakis(tertbutoxy)titanium(IV) from a direct liquid injection system at 200° C. are introduced with an exposure of 10 Torr-sec into an ALD reactor at 250° C., alternately with 20 nmol cm⁻² doses of water vapor at an exposure of 10 Torr-sec. A film of chromium(IV)-titanium(IV) oxide is deposited.

### Example 10

### Synthesis of Ditertbutoxy-Dineopentylchromium(IV)

To a suspension of chromium-trichloride-tris-tetrahydrofuran in diethyl ether was added dropwise, 2 mol equivalents of potassium tert-butoxide in diethy ether. The reaction was stirred for 15 minutes and trimethylsilylmethylmagnesium chloride in diethyl ether was added dropwise. The mixture was stirred for one hour and sublimed at 1 torr to give red-purple crystals of ditertbutoxy-dineopentylchromium(IV)

### Example 11

### Atomic Layer Deposition Ditertbutoxy-Dineopentykhromium(IV)

10 nmol cm⁻² doses of the vapor of di(tertbutoxy)di(neopentyl)chromium(IV) from a direct liquid injection system at 200° C. are introduced with an exposure of 10 Torr-sec into an ALD reactor at 250° C., alternately with 20 nmol cm⁻² doses of water vapor at an exposure of 10 Torr-sec. A film of chromium(IV) oxide is deposited.

### Example 12

### Atomic Layer Deposition of Calcium Chromium(IV) Oxide from bis(2,2,6,6-tetramethyl-3,5-heptanedionate)calcium(II), Tetrakis(Tertbutoxy)Chromium(IV), and Water

10 nmol cm⁻² doses of the vapor of tetrakis(tertbutoxy)chromium(IV) and bis(2,2,6,6-tetramethyl-3,5-heptanedionate)calcium(II) from a direct liquid injection system at 200° C. are introduced with an exposure of 10 Torr-sec into an ALD reactor at 250° C., alternately with 20 nmol cm⁻² doses of water vapor at an exposure of 10 Torr-sec. A film of calcium chromium(IV) oxide is deposited.

### Example 13

### Atomic Layer Deposition of Magnesium Chromium(IV) Oxide from bis(cyclopentadienyl)magnesium(II), Tetrakis(Tertbutoxy)Chromium(IV), and Water

10 nmol cm⁻² doses of the vapor of tetrakis(tertbutoxy)chromium(IV) and bis(cyclopentadienyl)magnesium(II) from a direct liquid injection system at 200° C. are introduced with an exposure of 10 Torr-sec into an ALD reactor at 250° C., alternately with 20 nmol cm⁻² doses of water vapor at an exposure of 10 Torr-sec. A film of magnesium chromium(IV) oxide is deposited.

Other variations on the synthetic methods, other chromium(IV) compounds, and materials deposition techniques will be apparent to those of skill in the art.

Although the present invention herein has been described with reference to various exemplary embodiments, it is to be understood that these embodiments are merely illustrative of the principles and applications of the present invention. Those having skill in the art would recognize that various modifications to the exemplary embodiments may be made, without departing from the scope of the invention.

Moreover, it should be understood that various features and/or characteristics of differing embodiments herein may be combined with one another. It is therefore to be understood that numerous modifications may be made to the illustrative embodiments and that other arrangements may be devised without departing from the scope of the invention.

Furthermore, other embodiments of the invention will be apparent to those skilled in the art from consideration of the specification and practice of the invention disclosed herein. It is intended that the specification and examples be considered as exemplary only, with a scope and spirit being indicated by the claims.

Finally, it is noted that, as used in this specification and the appended claims, the singular forms “a,” “an,” and “the,” include plural referents unless expressly and unequivocally limited to one referent, and vice versa. As used herein, the term “include” or “comprising” and its grammatical variants are intended to be non-limiting, such that recitation of an item or items is not to the exclusion of other like items that can be substituted or added to the recited item(s).

I claim:

1. A method of making a chromium composition, comprising: reacting a chromium compound having chromium in the formal oxidation state of +4 with an oxygen atom source.

2. The method of claim 1, wherein the oxygen atom source is chosen from water, oxygen, ozone, hydrogen peroxide, silanol, or aryl hydrate.

3. A method of making a thin film composition comprising:
treating a heated substrate with (A) one or more volatile chromium compounds in the formal oxidation state of +4 and (B) a gas or vapor chosen from water, oxygen, ozone, hydrogen peroxide, silanol, or aryl hydrate.

4. A method of making a composition having the chemical formula MCrO₃, comprising: reacting a chromium composition with an oxygen atom source and a salt of a divalent metal; wherein M is a divalent metal cation.

5. The method of claim 4, wherein the divalent metal cation is chosen from Be, Mg, Ca, Sr, Ba, Mn, Fe, Co, Ni, Cu, Zn Cd, Hg, Sn, or Pb.

6. The method of claim 4, wherein the Cr atom in the composition having the chemical formula MCrO₃ is in the +4 oxidation state.

7. The method of claim 4, wherein the oxygen atom source is chosen from water, oxygen, ozone, hydrogen peroxide, silanol, or aryl hydrate.

8. The method of claim 4, wherein the salt of a divalent metal is chosen from MgCl₂, CaO, or BaCO₃.

9. The method of claim 1, 3, or 4 wherein the chromium molecule has the structural formula 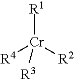
wherein each of R¹, R², R³, and R⁴ is independently chosen from a monoanionic ligand.

10. The method of claim 9 wherein each of R¹, R², R³, and R⁴ is independently chosen from a an alkyl, aryl, alkoxide, siloxide, amide, ether, imide, and amidine;
wherein each mono anionic ligand may be substituted or unsubstituted; and
wherein each alkyl may be saturated or unsaturated.

11. The method of any one of claim 9, wherein each of R¹, R², R³, R⁴ is independently chosen from O^{t}Bu, OCMe₂Et, OCMeEt₂, OCH^{t}Bu₂, 1-adamantoxide, NEt₂, NMeⁿBu, NⁿPr₂, NC₅H₁₀, NC₄H₄ (pyrolyl), CH₂SiMe₃, CH₂^{t}Bu, CH₂CPhMe₂, 1-norbornyl, cyclopentadienyl, or OSi^{t}Bu₂Me.

12. A method of making a composition comprising: reacting a compound having manganese in the formal oxidation state of +4 with water, oxygen, ozone, hydrogen peroxide, or aryl hydrate.
